(19) United States
(12) Patent Application Publication
(10) Pub. No.: US 2026/0320641 A1
(43) Pub. Date: Oct. 15, 2026

(54) QUANTIFYING CARBON OFFSET THROUGH INCENTIVIZING REUSE OF FUNCTIONAL ITEMS AS A DECORATIVE ITEM

(71) Applicant: Coty Inc., New York, NY (US)

(72) Inventors: Sue Nabi, New York, NY (US); Nicolas Vu, New York, NY (US); David Joyal, New York, NY (US)

(21) Appl. No.: 19/481,832

(22) PCT Filed: May 3, 2024
(86) PCT No.: PCT/US2024/027857

§ 371 Date: Nov. 5, 2025

Related U.S. Application Data
(60) Provisional application No. 63/500,410, filed on May 5, 2023.

(51) Int. Cl. G06Q 30/0207; G06Q 40/04

(52) U.S. Cl. CPC G06Q 30/0215; G06Q 40/055

(57) ABSTRACT

Systems and techniques for quantifying carbon offset through incentivizing reuse of functional items as a decorative item are described herein. A unique form of visual art, created by a user, incorporating at least one consumer package is received. A digital record is created in a computer database for the unique form of visual art. The digital record comprises at least one first record of an artcycling event based on receipt of the unique form of visual art. A value is assigned to the artcycling event based on an evaluation of visual elements present in the unique form of visual art. An account balance of the user is increased by an amount equal to the value.

### CROSS-REFERENCE TO RELATED APPLICATION

This application claims the benefit of priority to U.S. Provisional Patent Application Serial No. 63/500,410, filed May 5, 2023 entitled “QUANTIFYING CARBON OFFSET THROUGH INCENTIVIZING REUSE OF FUNCTIONAL ITEMS AS A DECORATIVE ITEM” the disclosure of which is incorporated herein in its entirety by reference.

### TECHNICAL FIELD

Embodiments described herein generally relate to carbon emissions management and, in some embodiments, more specifically to a portal for user submission of images of artcycle works made from discarded packaging with incentives in return for pledging not to dispose of an artcycle work.

### BACKGROUND

Product packaging protects an enclosed product during storage, shipping, and handling and also provides a pallet for providing product information. When the product is unpacked by an end user, the packaging is typically discarded. This means in a best case scenario the packaging is taken to a sanitary landfill or to a recycling facility. Landfills and recycling operations both emit byproducts such as gas, slag, etc. Artcycling is a technique whereby waste is reused in art installations as an artistic expression of an artist.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a process for data collection for improving and quantifying carbon offset through incentivizing reuse of functional items as a decorative item, according to an embodiment.

FIGS. 2A, 2B, 2C, and 2D illustrate an example of an artcycle capable bottle for improving and quantifying carbon offset through incentivizing reuse of functional items as a decorative item, according to an embodiment.

FIG. 3 illustrates an example of a stacked arrangement of artcycle capable bottles for improving and quantifying carbon offset through incentivizing reuse of functional items as a decorative item, according to an embodiment.

FIG. 4 illustrates an example of a process for a portal for improving and quantifying carbon offset through incentivizing reuse of functional items as a decorative item, according to an embodiment.

FIG. 5 illustrates an example of a method for improving and quantifying carbon offset through incentivizing reuse of functional items as a decorative item, according to an embodiment.

FIG. 6 is a block diagram illustrating an example of a machine upon which one or more embodiments may be implemented.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phrascology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma may be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts may be carried out in any order without departing from the principles of the invention, except when a temporal or operational sequence is explicitly recited. Furthermore, specified acts may be carried out concurrently unless explicit claim language recites that they be carried out separately. For example, a claimed act of doing X and a claimed act of doing Y may be conducted simultaneously within a single operation, and the resulting process will fall within the literal scope of the claimed process.

The term “about” as used herein may allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein may mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The methods and systems discussed herein improve artcycling rates and/or carbon offset rates by providing incentives to transform objects that would be typically disposed or recycled into artcycling works. The incentives encourage individuals to engage in reducing carbon footprint. The methods and systems discussed herein provide a number of benefits including reduction of costs associated with waste collection and artcycling and an increase in collection efficiency. The methods and techniques discussed herein enable a marketing channel for participating retailers to build value from being good corporate citizens. U.S. Pat. No. 10,318,960 generally describes methods and systems for improving recycling through the use of financial incentives. Conventional techniques for consumer-generated art using of brand assets may use nonfungible tokens (NFTs). However, NFT generation and management incurs an environmental cost associated with the computing resources used to generate NFTs. See e.g. https://www.packaginginsights.com/news/non-fungible-tokens-crypto-artcycling-propels-packaging-design-into-digital-ownership-age.html.

The systems and techniques discussed herein provide a stackable bottle system that creates a unique substrate for artcycling artistic expression and to minimize waste and energy consumption associated with artcycling or discarding a used package while promoting a new support for creating art and fostering artcycling. In an example, a series of interlocking bottles may be used as individual artistic elements or as combined to make an essentially contiguous surface that becomes a work of artcycling that is durable and unique to the consumer while minimizing waste associated with empty containers. A digital representation of the work of artcycling may be used to create NFTs, carbon offsets, etc.

In an example, the bottles may be blank or decorated with individual artistic expressions. The bottles may be stacked to create a variety of visual effects based on the combination of images and orientation of images determined by the order and orientation of stacking. The unique visual effect created by the individual and/or bottles as transformed by the artist into an artcycling output that may be used either as a standalone subject or paired with other visual elements to create a composite work of artcycling that is individual and unique to the creator.

In an example, bottle geometry and glass distribution may be specifically designed to offer a glass wall or glass canvas when assembled to allow artcycling expression on a vertical flat surface.

In some example embodiments, an individual physical work of artcycling may be created and assigned a value. In some example embodiments, a derivative work of a physical work of artcycling (e.g., a digital impression, etc.) may be created, for example, using a digital camera. The digital impression of the individual physical work of artcycling may be uploaded to a portal. The portal enables an ability to incorporate the digital version of the work into a metaverse (e.g., as an avatar, etc.). The digital version may be used to create an NFT associated with the digital version of the work. The portal enables the creator to create carbon offsets based on inclusion of the packaging into a work of artcycling together with a pledge to maintain the packaging as part of the work of artcycling rather than dispose the work as a recyclable or as refuse. The portal enables the creator to enter a contest available only to those who have created a composite work of artcycling.

Art valuation involves recognizing the unique challenges and opportunities presented by the digital landscape in an internet-based information exchange. The internet has fundamentally changed how information is disseminated and consumed, and this transformation extends to the art market. There are several technical challenges involved with enabling an internet-centric art valuation system. The internet provides an overwhelming amount of data, from auction results and gallery exhibitions to social media trends and online art critiques leading to data overload. Sifting through vast amounts of data to find relevant and reliable information for art valuation can be challenging if not impossible for humans. Establishing provenance and authenticity of artworks is more complex when transactions and exhibitions occur online. The risk of fraud and misrepresentation increases, affecting the trustworthiness of online art valuations without a system that can digitally verify an artwork using features imperceptible to humans, but perceptible by a special purpose computing system. While the internet provides global access to art markets, it also leads to market fragmentation with disparate platforms and standards. This can result in inconsistent valuations and difficulty in comparing artworks across different platforms without the objectivity and consistency of the specially programmed computing device. Online trends can shift rapidly, influenced by viral content and social media. Art valuations may become volatile, responding quickly to online hype rather than intrinsic artistic value.

To address these challenges, several internet-centric solutions can be implemented. Big data analytics and AI can be used to process and analyze large datasets from various online sources to derive meaningful insights for art valuation. This helps in filtering noise from valuable data, providing a more accurate and comprehensive basis for valuation. Blockchain technology can be implemented to create a tamper-proof ledger (e.g., a record, etc.) for provenance and transaction history of an artwork to enhances transparency and trust in online art transactions, supporting more reliable valuations. A centralized platform can be developed that aggregates data from various sources and standardizes art valuation processes across different markets to reduces market fragmentation and provides a consistent framework for comparing and valuing art globally. Machine learning models are used to analyze real-time data from social media and other online platforms to gauge public sentiment and trend to allow valuations to adapt dynamically to changing trends while maintaining a balance between market demand and intrinsic artistic value. Interactive platforms are created where art enthusiasts, collectors, and experts can contribute to and engage with the valuation process to democratize art valuation, incorporating a broader range of perspectives and reducing bias.

Both the challenges and solutions are deeply intertwined with digital technologies. Leveraging these technologies as described herein leads to more transparent, accurate, and democratic art valuations, aligning with the global and interconnected nature of the modern art market.

Unlike using brand assets to create NFTs unique to a creator, the methods and systems discussed herein enable a unique ability to utilize the quantified carbon offsets created by retaining packaging avoiding the carbon cost of trashing or recycling packaging (e.g., glass containers, etc.) to offset a cost of NFT generation and offset a carbon cost of manufacturing a product contained in the packaging (e.g., a fragrance, etc.).

In an example, acquisition and statistical analysis techniques are used for evaluating artcycling data. Evaluation of the artcycling data enables a variety of benefits including: monitoring of compliance with applicable laws, extraction of trends from populations of consumers, long term planning, performance analysis, and standardization of municipal grant applications.

In an example, tracking and analyzing of a carbon footprint is used to create the bottle, the fragrance contained the bottle, and/or the marketing sales activities associated with marketing and selling a bottle in order to design and implement effective strategies to increase artcycling. The data acquisition and analysis enables officials in all sectors of the economy to recognize and address trends on a micro and macro level in the following ways:

Accurately measure the effectiveness of artcycling programs on a geographic basis (e.g., by tonnages collected, artcycling rates, participation rates, etc.).

Provide detailed data describing the effectiveness of artcycling programs. For example, to help optimize route collection systems by matching carbon offset attributed to a project or a work of artcycling creation.

Manage effectiveness of an artcycling program at a household level of collection so that marketing campaigns may be designed to maximize adoption and use of artcycling.

The amount of a material (e.g., glass, etc.) that has been preserved with an original product purchaser rather than thrown out or recycled may be analyzed in conjunction with existing artcycling data, refuse management, production of packaging or fragrance, production of NFTs, etc. providing an accounting of energy use and economic activity. Information on the environmental effects of the various named activities may be quantified tangible proof of the benefits of artcycling certain materials may be generated to encourage a reduction of overall carbon footprint generation.

Data relating to artcycling is managed using a database system comprising an input for receiving information from a generated artcycling project. For example, data may be collected and stored in the database relating to an NFT generated from a physical artcycling project. The information may comprise sets of source identifications and associated recycled quantities. The database system may produce such information as: a geographic analysis module for analyzing geographic artcycling patterns of respective households, a historical analysis module for analyzing temporal trends of artcycling for one or more respective households, a value analysis module for analyzing valuations of certain artcycling projects and related NFTs made by various artcycling artists, and an incentive response module for determining a responsiveness of a respective household to artcycling incentives.

In an example, a unique rewards program is provided that enables provisioning of an economic incentive for households to increase their artcycling rate. An artcycling container is matched to an individual by providing an identifier such as a machine readable code (e.g., a bar code, radio frequency identification (RFID) tag, etc.) on the container to associate the container with the individual (e.g., based on a purchase, acquisition, etc.). A value of the artcycled object and related artistic expression are appraised via a metric or algorithm, by way of example and not limitation “Jerry Gogsian's Suggested Followers”, and assigns a monetary value to that artcycled object. An artcycled object owner or creator is provided with an opportunity to create a digitized version of the artcycled object (e.g., an NFT, etc.). A record of an artcycled object and a quantity of particular objects (e.g., one or more stackable fragrance bottles, etc.) are translated into a credit amount (e.g., “ArtCycleDollars”, etc.) and the credit amount is deposited into an account associated with the household. A household may redeem credits in their account, for example, at participating retailers for goods, services, coupons valued for goods or services, other benefits or discounts, as a carbon offset for the manufacture, sales and/or distribution of a fragrance, fragrance packaging, artcycle NFT generation, etc.

The household may view their account and view information such as the dates of their artcycling activity, the quantity recycled for a given period of time, how many credits they earned for artcycling, for a certain artcycling activity, the total amount of credits in their account, their shopping history with their credits, etc. The household may also order credits to be used for purchases at participating retailers.

A database and algorithms are utilized to assign a value to the household for artcycling and for the amount recycled. The assigned value may be a financial (e.g., monetary, economic, etc.) value. The database and algorithms enable flexibility to apply different reward rates for artcycling by household, street, township, city, state, etc. to ensure that households receive optimum impact of an incentive. The household may, for example, view their artcycling data on an Internet site which translates the amount of recycled material into a value and allows them to exchange the value for goods, services, coupons valued for goods or services, and/or other benefits or discounts.

In an example, a unique form of visual art may be formed that incorporates at least one consumer package created by a user. A representation of the unique form of visual art may be transmitted to a server. The server may access a database of packages comprising data concerning the carbon foot print thereof. A first value (F) may be generated that is a representation of the carbon footprint of the at least one consumer package used to form the unique form of visual art In an example, to establish the Carbon Footprint Value (F), the server accesses a database that contains detailed information about the carbon footprint of various consumer packages. This data may include emissions associated with the production, transportation, and disposal of the packages. The specific consumer packages used in the artwork are identified. This could be done manually by the artist or automatically through image recognition technologies in the server. For each identified package, corresponding carbon footprint data is retrieved from the database. The total carbon footprint value (F) for the artwork is calculated by summing up the carbon footprints of all the packages used in the artwork. This value represents the environmental impact in terms of carbon emissions.

A digital record may be created of the representation. The digital record may comprise at least one first record of an artcycling event based on receipt of the unique form of visual art. The at least one first record may comprise: a first indication of the artcycling event that indicates a time of creation of the unique form of visual art, a second indication of the artcycling event that indicates a pledge not to recycle or dispose of the at least one consumer package incorporated into the unique form of visual art, a visual depiction of the artcycling event, and the first value.

A second value (S) may be assigned to the record based on an evaluation of elements present in the unique form of visual art. In an example, the second value (S) is determined based on an evaluation of various elements present in the artwork. These elements could include artistic quality, creativity, use of materials, thematic expression, the integration of sustainable practices, etc. A scoring system may be established to assess these elements. This could involve ratings by art critics, public votes, or assessments by environmental experts focusing on the sustainability aspect of the artwork. Based on the evaluation, a score or value is assigned to the artwork, which reflects its artistic and environmental significance. This score could be influenced by how effectively the artwork uses recycled materials, promotes sustainability messages, or innovates in terms of material reuse.

A third value (T) may be generated from the first and second value. The third value is represented by the formula: (T)=WF*(F)+WS*(S).

WF and WS represent weights associated with the first (F) and second (S) values and are 0≤WF, WS≤1. The third value (T) is assigned to the digital record to generate a unique representation of the form of visual art.

The calculated values F (carbon footprint) and S (artistic and environmental evaluation) are integrated using the formula (T=WF\times F+WS\times S). WF and WS are predefined weights that determine relative importance of the carbon footprint versus the artistic/environmental score in the final valuation of the artwork. The resulting value T provides a comprehensive measure that reflects both the environmental impact and the artistic value of the artwork. This quantification process not only helps in assessing the environmental impact of the materials used but also promotes a holistic view by integrating artistic value, thereby encouraging more environmentally conscious art practices.

Machine learning (ML) may be used to enhance the scoring system and the assignment of scores in the context of evaluating artwork, particularly when it involves complex criteria like artistic quality and environmental impact that may be subjective if judged strictly be humans. The machine learning algorithm may be less prone to emotional or environmental factors that may artificially skew a score. Machine learning algorithms can analyze images or descriptions of the artwork to extract relevant features. These features might include: visual elements (e.g., color, texture, shape, composition, etc.), material identification (e.g., identifying types of consumer packages used through image recognition techniques, etc.), thematic elements (e.g., themes related to sustainability or environmentalism that might be present in the artwork, etc.). A dataset is prepared to effectively use ML which includes examples of artworks along with their manually scored evaluations (e.g., for carbon footprint and artistic/environmental value, etc.). This dataset serves as the training data. A machine learning model is trained on the dataset. This model learns to correlate the extracted features with the scores assigned by human experts. Different types of ML models could be used including, by way of example and not limitation, Regression Models (for continuous score prediction), Classification Models (if the scores are categorized into discrete classes (e.g., high, medium, low)), etc.

Once trained, the ML model can predict scores for new artworks based on their features. This automated scoring can help in scalability (e.g., quickly scoring a large number of artworks, etc.) and consistency (e.g., reducing human bias or variability in scoring, etc.). The system can be designed to incorporate feedback mechanisms where the predicted scores are periodically reviewed and corrected by human experts. This feedback can be used to retrain and improve the ML model, enhancing its accuracy and reliability over time.

For the carbon footprint (F), ML can assist in predicting the environmental impact based on historical data of similar materials used in other artworks. Predictive models can estimate emissions based on factors like material type, quantity, and processing methods used. Machine learning can also be used to perform more complex analyses, such as identifying trends in material usage, predicting future sustainability trends in art, or analyzing the impact of certain materials or practices over time. To calculate the carbon footprint of artworks, especially those that incorporate consumer packaging or other materials, a more detailed analysis of various factors may be enabled using ML. Additional features can be extracted and considered to enhance the accuracy of the carbon footprint calculation including material composition that may include material type because different materials have varying environmental impacts. For instance, plastics typically have a higher carbon footprint than biodegradable materials. The material composition feature may include a quantity of each material that represents an amount of each material used that may affect the total carbon footprint.

A source of materials feature may be extracted that represents recycled content because materials that are recycled generally have a lower carbon footprint compared to new materials. The source of materials feature may also include geographical origin because a distance materials have traveled from their point of origin to a studio of the artist may impact the carbon footprint due to transportation emissions.

A manufacturing processes feature may be extracted that includes energy consumption to represent an amount of energy used in the production of the materials and a type of energy used that indicates whether the energy comes from renewable sources or fossil fuels which may affect the carbon footprint.

A transportation feature may be extracted that includes mode of transportation to reflect that different modes (e.g., air, sea, road) have varying emissions profiles and efficiency of transportation to reflect that bulk shipping, for instance, might reduce the per-unit carbon footprint compared to individual shipments.

A usage phase feature may be extracted that represents durability of materials because more durable materials might lead to a lower footprint over time if the artwork lasts longer and reduces the need for replacement materials and maintenance required because some artworks might require energy or additional materials for maintenance, affecting their overall environmental impact.

An end-of-life feature may be extracted that includes disposal methods that indicate whether materials are disposed of in landfills, recycled, or composted can affect the total carbon footprint and biodegradability to reflect that biodegradable materials can have a lower environmental impact at the disposal phase.

A lifecycle assessment (LCA) feature may be extracted that includes a comprehensive LCA based on a full lifecycle assessment of the materials used to provide a detailed view of the environmental impact from production to disposal.

Environmental certifications may be extracted as features that include certifications and labels of materials that are certified by environmental standards (e.g., FOREST STEWARDSHIP COUNCIL (FSC) for wood, ENERGY STAR for electronic components, etc.) that might indicate a lower carbon footprint. Technological and process innovations features may be extracted to indicate usage of new technologies or innovative practices in the production or processing of materials that reduce environmental impact.

By extracting and analyzing these features, a more comprehensive and accurate calculation of the carbon footprint of artworks can be achieved. This not only helps in assessing the environmental impact but also promotes transparency and accountability in the art community, encouraging more sustainable practices.

By integrating machine learning into the scoring system, the process becomes more efficient and scalable and also gains the potential to uncover deeper insights through data-driven analysis. This approach may enhance the way artworks are evaluated, particularly in contexts where environmental impact and artistic innovation are key considerations.

An economic and environmental impact of the artcycling efforts may be calculated in participating communities. One or more marketing channels may be generated that involve participating retailers who may benefit from an increase in brand value from their commitment to the environment and artcycling and to local communities served by the artcycling program. A tax burden to a government and businesses associated with waste disposal is reduced by enabling users to earn rewards for artcycling.

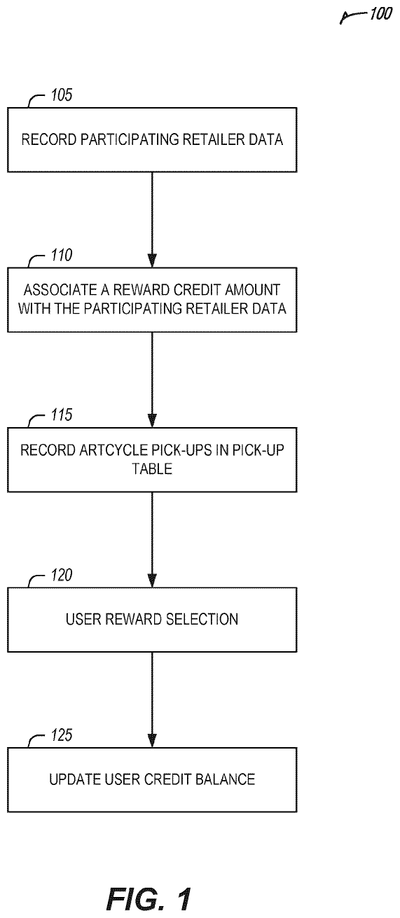

FIG. 1 illustrates an example of a process 100 for data collection for improving and quantifying carbon offset through incentivizing reuse of functional items as a decorative item, according to an embodiment.

At operation 105, participating retailer data is recorded in a database. The participating retailer data includes data associated with a participating retailer reward program. At operation 110, a credit amount is associated with the participating retailer reward program. In an example, data may be provided from an artcycling registration site as a text file (e.g., a file with a .txt extension, etc.), an extensible markup file (XML) file, or another electronic data format. The data file may include a variety of fields/columns including, by way of example and not limitation:
(1) A customer ID, account ID, or container ID, which may include: an RFID tag number as the first 23 characters or digits; an 8-digit numeric fixed-length barcode or keyboard entry; another ID number; and a zero sequence code of the form “99999999999999999999999”; (2) Year 2000 (Y2K) compliant transaction date (e.g., in format MM/DD/YYYY, etc.); (3) Time (e.g., in 24-hour clock format HH:MM:00, etc.); (4) Assessed artcycle value (e.g., as appraised by an individual, an algorithm, etc.); (5) Gross Weight (e.g., in 6 digit numeric format, etc.).

In an example, a user earns more credits as the user artcycles more material. For example, for each stackable individual bottle that the user (1) pledges not to dispose of into trash or recycling and (2) incorporates into an artcycling object, the user is given “X” account credits in the form of, for example, Artcycle Dollars. The number of credits that one residence may earn per month may be capped. For example, the monthly per household earning cap may be set at $20.

When the data file is submitted, fields and tables are updated for each user. Fields and columns that are update may include, by way of example and not limitation: (1) Total value of artcycled objects to date. For example, a weight of each artcycle pick-up is added to an accumulative weight and results in a total weight of all items artcycled by the user since their account was opened; (2) Account Credit Amount. For example, a weight of each artcycle pick-up at a residence (e.g., as reflected in the data file) is translated to account credits. This credit amount is added to an existing account balance for the given user.

At operation 115, each pick-up record is inserted into a pickups data table. The pickups data table is stored in a database (e.g., a MICROSOFT® SQL Server database, etc.) and is connected to through an open databased connectivity (ODBC) connection. Upon insertion, each pick-up record is given a unique identifier by the database for later reference.

When a user enters the portal (e.g. a website, etc.), they login using an account number and password. Because each user or residence has a unique account number, each user has only one login.

When the a user logs in with their account, they may view their account overview, which may include, by way of example and not limitation: artcycling activity and a number of credits that they have earned for artcycling; net recyclables to date; amount recycled in a given week; amount and/or date of last pick-up; and shopping history. The user may review account information and/or artcycling information, use their account balance to shop, and learn about community environmental initiatives.

The user is able to view participating retailers and rewards. To go shopping, a user selects a desired vendor(s). For each of the selected vendors, the user designates an amount of account credits to spend. This value is then deducted from the account of the user. For example, if a user chooses to spend $10 at three different vendors, then a total of $30 dollars is deducted from the account of the user.

At operation 120, the user may choose rewards in exchange for the credits in their account. At operation 125, the value of the reward is deducted from their account. Upon the user designating the vendor and the dollar amount, a coupon or other item redeemable for goods may be shipped to an address associated with the user account. The user may not spend more account credits than exists in their account unless a mechanism for borrowing against future credits is defined which may lead to a different psychological incentive to encourage artcycling.

A report is generated that shows a date/time that a user ordered rewards. A reward and fulfillment process is initiated to deliver the reward to the address of the user.

The data collected is analyzed for artcycling rates, participation rates, route efficiency, and performance analysis. Various reports may be generated using data present in the database. Example reports include, by way of example and not limitation, a Single User Report, a Full User Report, a Single Vendor Report, a Vendor Report, a Vendor Report Graph, a Monthly Overview Report, an Analysis of Artcycling and Participation Rates, a Daily Report of Artcycle Rewards Ordered.

An administrator may export a user report of each user that includes user activity including artcycling history, history of obtaining credits, and use of credits at participating retailers. The administrator may also export a system report containing an overview of the system. The system report includes, by way of example and not limitation, Individual Vendor Reports, Overview Reports, Hauler Reports, and User Reports.

Reports may be run on the variety of data in the system. Reports may be generated at any time or at regular time intervals such as weekly, monthly or yearly.

A single user report may include displaying artcycling history, earnings, and order activity of a user. The single user report displays current and past artcycling data for an individual user. The data includes, by way of example and not limitation, Current Balance, Credits Earned This Month, and Report Data Range. The single user report includes artcycling history of the user with records of earnings on dates recycled. The report also includes an order history of the user with dates and contents of each order.

A full user report includes a display of artcycling history of a group of users. In an example, the full user report may be generated by Collection Route, Zip, Street, and Route. Data included in the full user report includes, by way of example and not limitation Account Number, RFID #, User Address, and Current Balance.

A single vendor report displays a list of users that have used their credits to shop at a particular vendor. In an example, the Single Vendor Report may be generated for each individual vendor. The single vendor report displays activity between individual users and a selected Vendor. The data in the single vendor report includes, by way of example and not limitation User Address, City, State, Zip; Rewards Ordered from a selected Vendor, Date of First Order, Date of Last Order, and Percentage of credits used at the selected Vendor.

A vendor report displays how a collective group of users have used their credits. In an example, the vendor report may be generated by collection route, zip code, or by street. The report displays the most popular vendors (e.g., by percentage of credits spent, total credits spent, etc.) for a selected group of users. Data in the vendor report includes, by way of example and not limitation Coupon Percentage, Vendor Name, Coupon Count, and Total Credits.

A vendor report graph displays how a group of users have used their credits. In an example, the vendor report graph may be generated by zip, or by street for all vendors in the system. The vendor report graph illustrates the most popular vendors for a selected group of users or in the entire system. As a bar graph, the report displays vendors on the Y-axis and coupon percentage on the X-axis.

A monthly overview report displays participation rates and of a group of users over a given time period. In an example, the monthly overview report may be generated illustrating participation rates for the past 4 weeks. In an example, a second series illustrates weekly participation rates displaying percentages of participating users for all weeks in the system. In an example, a third series illustrates a monthly overview displaying participating users on a monthly basis. In an example, a fourth series illustrates weekly average and median artcycle value recycled for users.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the artcycling, and that such modifications and variations are considered to be within the scope of aspects of the present invention.

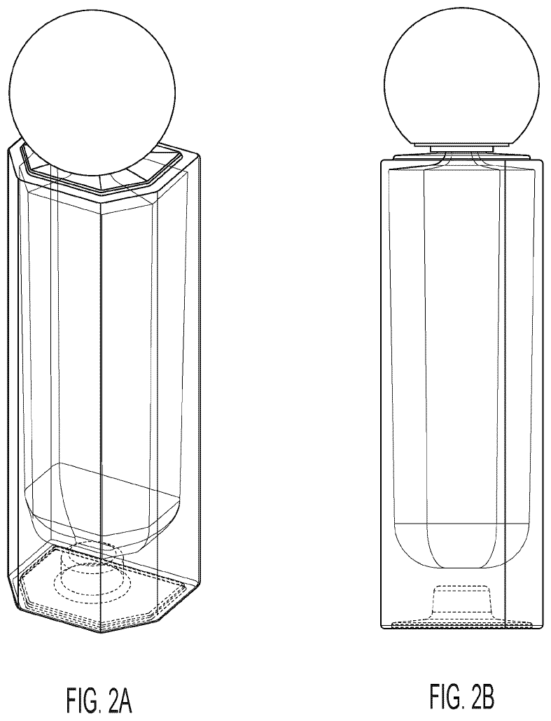

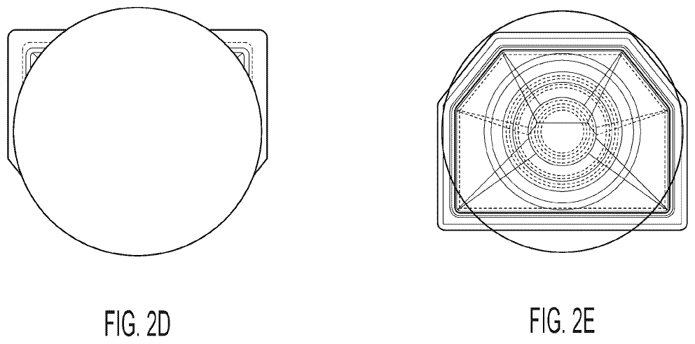

FIGS. 2A, 2B, 2C, and 2D illustrate an example of an artcycle capable bottle for improving and quantifying carbon offset through incentivizing reuse of functional items as a decorative item, according to an embodiment. FIG. 2A illustrates a side view of an example artcycle capable bottle, according to an embodiment. FIG. 2B illustrates a front view of an example artcycle capable bottle, according to an embodiment. FIG. 2C illustrates a top view of an example of an artcycle capable bottle, according to an embodiment. FIG. 2D illustrates a bottom view of the an example of an artcycle capable bottle, according to an embodiment. As shown in FIGS. 2A, 2B, 2C, and 2D the example bottle includes a recess into which the top of another example bottle may be inserted to couple the bottles in creating an artcycle work.

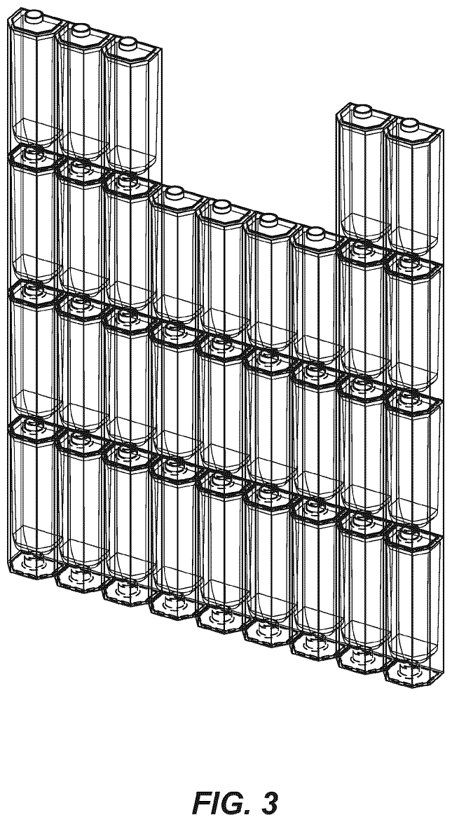

FIG. 3 illustrates an example of a stacked arrangement of artcycle capable bottles for improving and quantifying carbon offset through incentivizing reuse of functional items as a decorative item, according to an embodiment. As shown in FIG. 3, artcycle capable bottles (e.g., the artcycle capable bottle illustrated in FIGS. 2A, 2B, 2C, and 2D, etc.) may be stacked or otherwise arranged using features built into the bottles such as connecting mechanisms. A user may use the bottles to create a substrate for an artcycle work or the arrangement and other decorative elements may comprise the artcycle work.

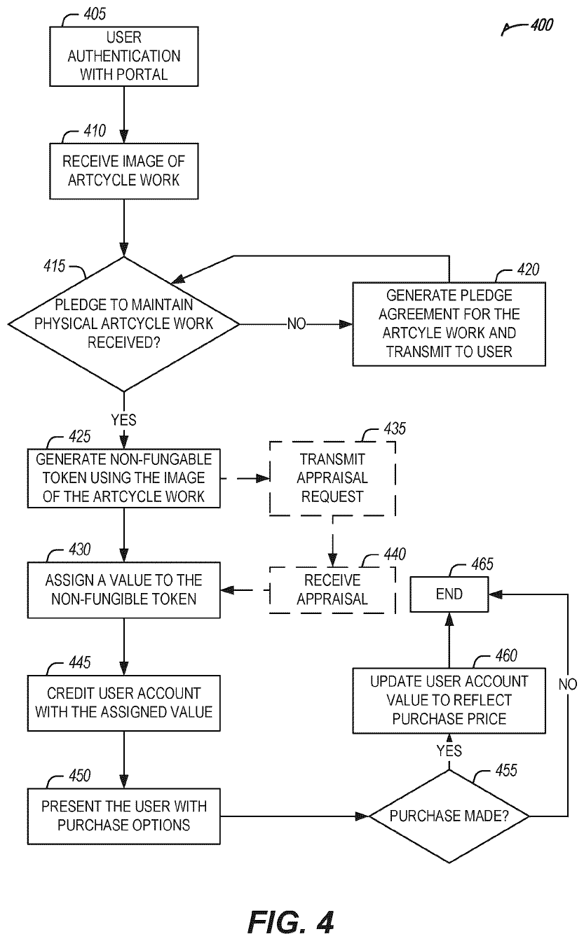

FIG. 4 illustrates an example of a process 400 for a portal for improving and quantifying carbon offset through incentivizing reuse of functional items as a decorative item, according to an embodiment.

At operation 405, a user authenticates with the artcycle portal. In the case of a user that is a first time visitor to the portal, the user will be prompted to create a user account and will be prompted to accept the user agreements and provide user data to generate and populate a user profile.

At operation 410, the user uploads or otherwise provides an image of a physical artcycle work that they have created and would like to add to their user profile. For example, the user may use the example bottle as shown in FIGS. 2A, 2B, 2C, and 2D or a plurality of the example bottles to create an artcycle work. The user captures an image of the artcycle work using a digital camera. In an example, an image capture component of the portal may be used to take control of an imaging device included with a user computing device to capture the image to prevent tampering, counterfeiting, or other fraudulent activity.

At decision 415, it is determined if the user has completed a pledge to maintain the physical version of the subject artcycle work. For example, the user may pledge not to recycle or dispose of the artcycle work in the trash. In an example, the user may be allowed to sell the artcycle piece to a collector or perform otherwise dispose of the artcycle work in ways that prevent the artcycle work from entering a landfill or recycling facility.

If it is determined at decision 415 that the user has not completed the pledge, a pledge is generated and transmitted to a display of the user at operation 420. If it is determined at decision 415 that the user has completed the pledge, a non-fungible token (NFT) is generated using the image of the artcycle work at operation 425.

At operation 430, a value is assigned to the NFT. The value may be based on a number of packages (e.g., the example bottles, etc.) are identified as being used in the image, based on complexity of the artcycle piece, etc. Features that may be used to assign a value to the NFC may be gathered from the image using a variety of image analysis and machine learning techniques to evaluate complexity, number of component items, etc.

In an example, an appraisal may be requested at operation 435.

The appraisal request may be transferred to an art or artcycle appraiser, a community of artcycle reviewers, an automated appraisal service, etc. An appraisal may be returned at operation 440 and the value assigned to the NFT may be based on the appraisal received.

At operation 445, an account of the user is credited with the assigned value. For example, if the value of the NFT is appraised at $30, the account balance of the user is increased by $30. At operation 450, the user is presented with purchase options. The purchase options may include contest entries, various carbon offsets, coupons, products, digital content, and the like.

At decision 455, it is determined if the user has made a purchase. If so, the account of the user is decreased by the amount of the purchase at operation 460. The purchase is moved to a fulfillment process for delivery to the user. When the user has completed making purchases or it is determined that the user has not made a purchase, the process 400 ends at operation 465.

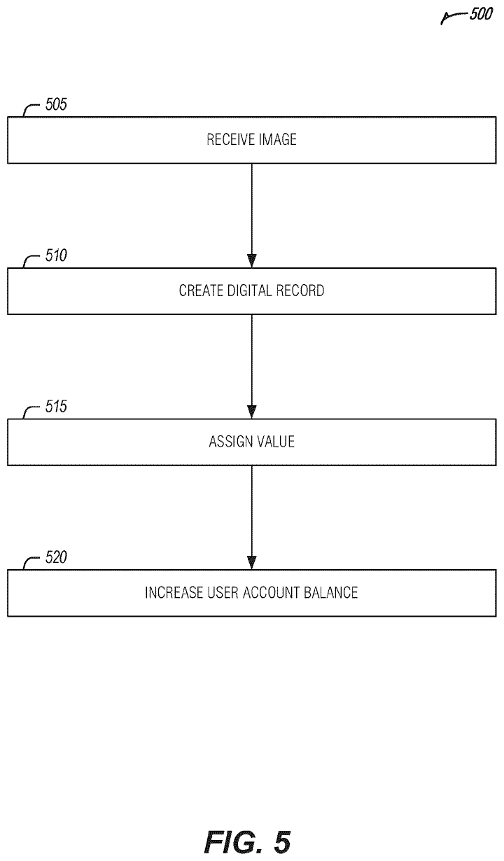

FIG. 5 illustrates an example of a method 500 for improving and quantifying carbon offset through incentivizing reuse of functional items as a decorative item, according to an embodiment. The method 500 may provide features as described in FIGS. 1 and 3 and may used the example bottle as shown in FIGS. 2A, 2B, 2C, and 2D.

At operation 505, an image is received of a unique form of visual art incorporating at least one consumer package created by a user.

At operation 510, a digital record is created in a computer database for the unique form of visual art incorporating at least one consumer package. The digital record comprises at least one first record of an artcycling event based on receipt of the image and the at least one first record comprises: a first indication of the artcycling event, a second indication of the artcycling event, and a visual depiction of the artcycling event. The first indication indicates a time of creation of the unique form of visual art and the second indication indicates a pledge not to recycle or dispose of the at least one consumer package incorporated into the unique form of visual art.

At operation 515, a value is assigned to the artcycling event based on an evaluation of elements present in the image. In an example, the value may be calculated using an external appraisal or valuation algorithm. At operation 520, an account balance of the user is increased by an amount equal to the value. In an example, valuation may integrate with gallery data by collecting data from various prestigious galleries that exhibit the art pieces. This may include exhibition history, sales data, gallery reputation, etc. Gallery Influence is used to incorporate a weighting system where the reputation and historical significance of the gallery contributes to valuation of an artwork. Community engagement may be sought through prestige web portal that implement a feature where individuals who have visited specific galleries can provide feedback or rate artworks. This may be implemented as a mobile app, website, etc. or may use an existing service such as, by way of example and not limitation, LiveArt of Rockland, New York. The prestige website develops a network or “prestige web” that connects users based on the galleries they have visited and the artworks they have interacted with. This network can help in identifying influential users whose opinions might carry more weight in the valuation process. Algorithmic valuation adjustment may be used that incorporates feedback using machine learning algorithms to analyze user feedback and adjust the art valuation accordingly. The feedback can be quantitatively integrated into the existing valuation model. Reputation metrics may be developed to evaluate the prestige or influence of both galleries and users within the prestige web, influencing the artwork's valuation based on these metrics. Transparency and dynamic updates using real-time data ensure that the valuation system updates in real-time or near-real-time as new feedback and exhibition data are entered. Open analytics provide tools for users to see how valuations are being influenced by different factors, enhancing transparency.

In an example, a non-fungible token may be generated for the unique form of visual art incorporating the at least one consumer package using the image. In an example, the non-fungible token may be submitted to a non-fungible token exchange. The non-fungible token exchange may include a trading or exchange interface that facilitates trading and exchange of the non-fungible token among users. Upon receipt of an exchange or trade transaction settlement, the account balance of the user may be increased by an amount specified in the exchange or trade transaction settlement In an example, the trading or exchange interface may include an exchange interface with controls that enable the user to exchange the non-fungible token for a carbon offset, a. promotional store redemption, or a currency. In an example, the promotional store redemption converts at least a portion of credits of a single type in an account of the user into rewards redeemable from one or more third party providers. The rewards comprise one of a good, a service, a coupon for a good, a coupon for a service, or other economic benefit from the one or more third party providers. Each third party vendor of the one or more third party providers may be a different vendor, service provider, or retailer. The rewards may be generated by the computer database and may be deposited in the account of the user.

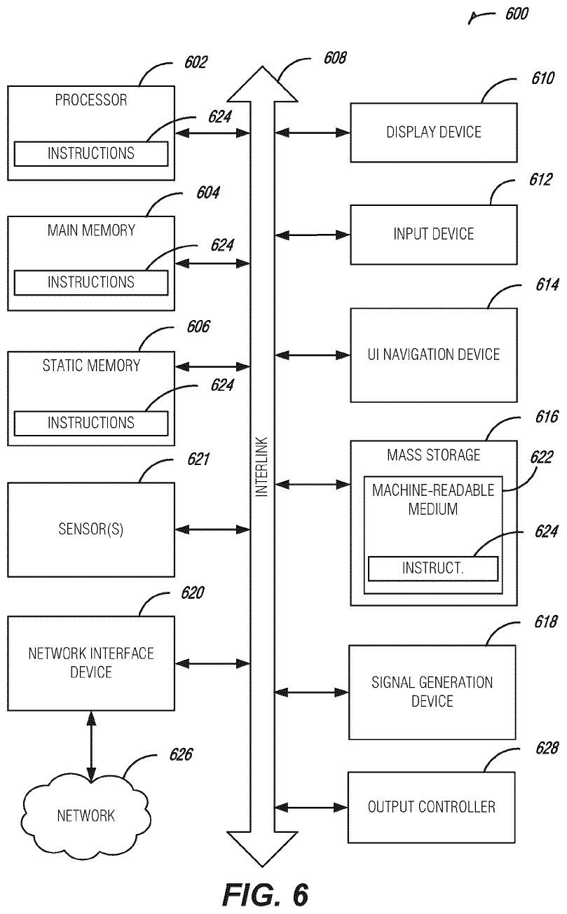

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensors. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### EXAMPLES

Example 1 is a system comprising: at least one processor, and memory comprising instructions that, when executed by the at least one processor, cause the at least one processor to perform operations to: receive a unique form of visual art, created by a user, incorporating at least one consumer package; create a digital record, in a computer database, for the unique form of visual art, wherein the digital record comprises at least one first record of an artcycling event based on receipt of the unique form of visual art, and wherein the at least one first record comprises: a first indication of the artcycling event, wherein the first indication indicates a time of creation of the unique form of visual art; a second indication of the artcycling event, wherein the second indication indicates a pledge not to recycle or dispose of the at least one consumer package incorporated into the unique form of visual art; and a visual depiction of the artcycling event; assign a value to the artcycling event based on an evaluation of visual elements present in the unique form of visual art; and increase an account balance of the user by an amount equal to the value.

In Example 2, the subject matter of Example 1, wherein the visual art is in the form of an image.

In Example 3, the subject matter of Example 2 includes, the memory further comprising instructions that, when executed by the at least one processor, cause the at least one processor to perform operations to generate a. non-fungible token for the unique form of visual art using the image.

In Example 4, the subject matter of Examples 1-3, wherein the value is calculated using an external appraisal or valuation algorithm.

In Example 5, the subject matter of Examples 3-4 includes, the memory further comprising instructions that, when executed by the at least one processor, cause the at least one processor to perform operations to: submit the non-fungible token to a non-fungible token exchange, wherein the non-fungible token exchange includes a trading or exchange interface facilitating trading and exchange of the non-fungible token among users; and upon receipt of an exchange or trade transaction settlement, increase the account balance of the user by an amount specified in the exchange or trade transaction settlement.

In Example 6, the subject matter of Example 5, wherein the trading or exchange interface includes an exchange interface with controls that enable the user to exchange the non-fungible token for a carbon offset, a promotional store redemption, a charitable donation, or a currency.

In Example 7, the subject matter of Example 6 includes, the memory further comprising instructions that, when executed by the at least one processor, cause the at least one processor to perform operations to: calculate a value for the nonfungible token; and assign the value to the non-fungible token.

In Example 8, the subject matter of Example 7, wherein the value is calculated in a form of an acquisition benefit.

In Example 9, the subject matter of Examples 7-8, wherein the value is calculated value in a form of a royalty stream.

In Example 10, the subject matter of Examples 6-9, wherein the value is allocated among a plurality of non-fungible token exchanges.

In Example 11, the subject matter of Examples 1-10 includes, the memory further comprising instructions that, when executed by the at least one processor, cause the at least one processor to perform operations to: train a machine learning processor using features extracted from training data comprising images of artworks and corresponding carbon footprint data, artwork valuation data, and carbon footprint adjusted valuation data to generate a carbon footprint valuation model; receive the unique form of visual art as input to the machine learning processor; and evaluate features extracted from the input using the carbon footprint valuation model to calculate the value for the artcycling event.

In Example 12, the subject matter of Examples 1-11 includes, the memory further comprising instructions that, when executed by the at least one processor, cause the at least one processor to perform operations to: access a database of an internet art valuation portal including a plurality of artworks, corresponding valuation data, and historical exhibition data from a plurality of galleries considered prestigious; extract, by the at least one processor, a set of features from the unique form of visual art, wherein the features include at least one of visual characteristics, artist information, and historical sales data; apply a comparative machine learning model that has been trained on the plurality of artworks and corresponding valuation data, wherein the model compares the extracted features of the unique form of visual art against similar features of artworks in the database; adjust, by the at least one processor, an initial valuation derived from the comparative machine learning model based on, historical exhibition data of the artworks in the database in prestigious galleries and influence scores of the galleries where artworks have been exhibited, wherein the influence scores are derived from the frequency and recency of exhibitions correlated with market trends; generate, by the processor, a valuation output for the unique from of visual art based on the adjusted valuation, wherein the valuation output is displayed to a user through the internet-based portal; and dynamically updating, by the processor, the comparative machine learning model based on new artworks and valuation data entered into the database, and new exhibition data from the prestigious galleries, to refine future valuations.

Example 13 is a computer implemented method comprising: receiving a unique form of visual art, created by a user, incorporating at least one consumer package; creating a digital record, in a computer database, for the unique form of visual art, wherein the digital record comprises at least one first record of an artcycling event based on receipt of the unique form of visual art, and wherein the at least one first record comprises: a first indication of the artcycling event, wherein the first indication indicates a time of creation of the unique form of visual art; a second indication of the artcycling event, wherein the second indication indicates a pledge not to recycle or dispose of the at least one consumer package incorporated into the unique form of visual art; and a visual depiction of the artcycling event; assigning a value to the artcycling event based on an evaluation of visual elements present in the unique form of visual art; and increasing an account balance of the user by an amount equal to the value.

In Example 14, the subject matter of Example 13, wherein the visual art is in the form of an image.

In Example 15, the subject matter of Example 14 includes, generating a non-fungible token for the unique form of visual art using the image.

In Example 16, the subject matter of Examples 13-15, wherein the value is calculated using an external appraisal or valuation algorithm.

In Example 17, the subject matter of Examples 15-16 includes, submitting the non-fungible token to a non-fungible token exchange, wherein the non-fungible token exchange includes a trading or exchange interface facilitating trading and exchange of the non-fungible token among users; and upon receipt of an exchange or trade transaction settlement, increasing the account balance of the user by an amount specified in the exchange or trade transaction settlement.

In Example 18, the subject matter of Example 17, wherein the trading or exchange interface includes an exchange interface with controls that enable the user to exchange the non-fungible token for a carbon offset, a promotional store redemption, a charitable donation, or a currency.

In Example 19, the subject matter of Example 18 includes, calculating a value for the nonfungible token; and assigning the value to the non-fungible token.

In Example 20, the subject matter of Example 19, wherein the value is calculated in a form of an acquisition benefit.

In Example 21, the subject matter of Examples 19-20, wherein the value is calculated value in a form of a royalty stream.

In Example 22, the subject matter of Examples 18-21, wherein the value is allocated among a plurality of non-fungible token exchanges.

In Example 23, the subject matter of Examples 13-22 includes, training a machine learning processor using features extracted from training data comprising images of artworks and corresponding carbon footprint data, artwork valuation data, and carbon footprint adjusted valuation data to generate a carbon footprint valuation model; receiving the unique form of visual art as input to the machine learning processor; and evaluating features extracted from the input using the carbon footprint valuation model to calculate the value for the artcycling event.

In Example 24, the subject matter of Examples 13-23 includes, accessing a database of an internet art valuation portal including a plurality of artworks, corresponding valuation data, and historical exhibition data from a plurality of galleries considered prestigious; extracting, by the at least one processor, a set of features from the unique form of visual art, wherein the features include at least one of visual characteristics, artist information, and historical sales data; applying a comparative machine learning model that has been trained on the plurality of artworks and corresponding valuation data, wherein the model compares the extracted features of the unique form of visual art against similar features of artworks in the database, adjusting, by the at least one processor, an initial valuation derived from the comparative machine learning model based on, historical exhibition data of the artworks in the database in prestigious galleries and influence scores of the galleries where artworks have been exhibited, wherein the influence scores are derived from the frequency and recency of exhibitions correlated with market trends; generating, by the processor, a valuation output for the unique from of visual art based on the adjusted valuation, wherein the valuation output is displayed to a user through the internet-based portal; and dynamically updating, by the processor, the comparative machine learning model based on new artworks and valuation data entered into the database, and new exhibition data from the prestigious galleries, to refine future valuations.

Example 25 is at least one machine-readable medium including instructions that, when executed by processing circuitry, cause the processing circuitry to perform operations to perform any of the computer implemented methods of Examples 13-22.

Example 26 is at least one machine-readable medium comprising instructions that, when executed by at least one processor, cause the at least one processor to perform operations to: receive a unique form of visual art, created by a user, incorporating at least one consumer package; create a digital record, in a computer database, for the unique form of visual art, wherein the digital record comprises at least one first record of an artcycling event based on receipt of the unique form of visual art, and wherein the at least one first record comprises: a first indication of the artcycling event, wherein the first indication indicates a time of creation of the unique form of visual art; a second indication of the artcycling event, wherein the second indication indicates a pledge not to recycle or dispose of the at least one consumer package incorporated into the unique form of visual art; and a visual depiction of the artcycling event; assign a value to the artcycling event based on an evaluation of visual elements present in the unique form of visual art; and increase an account balance of the user by an amount equal to the value.

In Example 27, the subject matter of Example 26, wherein the visual art is in the form of an image.

In Example 28, the subject matter of Example 27 includes, instructions that, when executed by the at least one processor, cause the at least one processor to perform operations to generate a non-fungible token for the unique form of visual art using the image.

In Example 29, the subject matter of Examples 26-28, wherein the value is calculated using an external appraisal or valuation algorithm.

In Example 30, the subject matter of Examples 28-29 includes, instructions that, when executed by the at least one processor, cause the at least one processor to perform operations to: submit the non-fungible token to a non-fungible token exchange, wherein the non-fungible token exchange includes a trading or exchange interface facilitating trading and exchange of the non-fungible token among users; and upon receipt of an exchange or trade transaction settlement, increase the account balance of the user by an amount specified in the exchange or trade transaction settlement.

In Example 31, the subject matter of Example 30, wherein the trading or exchange interface includes an exchange interface with controls that enable the user to exchange the non-fungible token for a carbon offset, a promotional store redemption, a charitable donation, or a currency.

In Example 32, the subject matter of Example 31 includes, instructions that, when executed by the at least one processor, cause the at least one processor to perform operations to: calculate a value for the nonfungible token; and assign the value to the non-fungible token.

In Example 33, the subject matter of Example 32, wherein the value is calculated in a form of an acquisition benefit.

In Example 34, the subject matter of Examples 32-33, wherein the value is calculated value in a form of a royalty stream.

In Example 35, the subject matter of Examples 26-34, wherein the value is allocated among a plurality of non-fungible token exchanges.

In Example 36, the subject matter of Examples 26-35 includes, instructions that, when executed by the at least one processor, cause the at least one processor to perform operations to: train a machine learning processor using features extracted from training data comprising images of artworks and corresponding carbon footprint data, artwork valuation data, and carbon footprint adjusted valuation data to generate a carbon footprint valuation model; receive the unique form of visual art as input to the machine learning processor; and evaluate features extracted from the input using the carbon footprint valuation model to calculate the value for the artcycling event.

In Example 37, the subject matter of Examples 26-36 includes, instructions that, when executed by the at least one processor, cause the at least one processor to perform operations to: access a database of an internet art valuation portal including a plurality of artworks, corresponding valuation data, and historical exhibition data from a plurality of galleries considered prestigious; extract, by the at least one processor, a set of features from the unique form of visual art, wherein the features include at least one of visual characteristics, artist information, and historical sales data; apply a comparative machine learning model that has been trained on the plurality of artworks and corresponding valuation data, wherein the model compares the extracted features of the unique form of visual art against similar features of artworks in the database; adjust, by the at least one processor, an initial valuation derived from the comparative machine learning model based on, historical exhibition data of the artworks in the database in prestigious galleries and influence scores of the galleries where artworks have been exhibited, wherein the influence scores are derived from the frequency and recency of exhibitions correlated with market trends; generate, by the processor, a valuation output for the unique from of visual art based on the adjusted valuation, wherein the valuation output is displayed to a user through the internet-based portal; and dynamically updating, by the processor, the comparative machine learning model based on new artworks and valuation data. entered into the database, and new exhibition data from the prestigious galleries, to refine future valuations.

Example 38 is a computer-implemented method comprising: forming a unique form of visual art incorporating at least one consumer package created by a user; transmitting to a server a representation of the unique form of visual art; accessing by the server of a database of packages comprising data concerning the carbon foot print thereof, generating a first value (F), wherein the first value is a representation of the carbon footprint of the at least one consumer package used to form the form of visual art; creating a digital record of the representation, wherein the digital record comprises at least one first record of an artcycling event based on receipt of the unique form of visual art, and wherein the at least one first record comprises: a first indication of the artcycling event, wherein the first indication indicates a time of creation of the unique form of visual art, a second indication of the artcycling event, wherein the second indication indicates a pledge not to recycle or dispose of the at least one consumer package incorporated into the unique form of visual art; a visual depiction of the artcycling event; and the first value assigning a second value (S) to the record based on an evaluation of elements present in the unique form of visual art; and generating a third value (T) from the first and second value, wherein the third value is represented by the formula: (T)=WF*(F)+WS*(S) wherein WF and WS represent weights associated with the first (F) and second (S) values and are 0≤WF, WS≤1; and assigning the third value (T) to the digital record to generate a unique representation of the form of visual art.

Example 39 is at least one machine-readable medium including instructions that, when executed by processing circuitry, cause the processing circuitry to perform operations to implement of any of Examples 1-38.

Example 40 is an apparatus comprising means to implement of any of Examples 1-38.

Example 41 is a system to implement of any of Examples 1-38.

Example 42 is a method to implement of any of Examples 1-38.

1. A system comprising:
at least one processor; and
memory comprising instructions that, when executed by the at least one processor, cause the at least one processor to perform operations to:
receive a unique form of visual art, created by a user, incorporating at least one consumer package;
create a digital record, in a computer database, for the unique form of visual art, wherein the digital record comprises at least one first record of an artcycling event based on receipt of the unique form of visual art, and wherein the at least one first record comprises:
a first indication of the artcycling event, wherein the first indication indicates a time of creation of the unique form of visual art;
a second indication of the artcycling event, wherein the second indication indicates a pledge not to recycle or dispose of the at least one consumer package incorporated into the unique form of visual art; and
a visual depiction of the artcycling event;
assign a value to the artcycling event based on an evaluation of visual elements present in the unique form of visual art; and
increase an account balance of the user by an amount equal to the value.

2. The system of claim 1, wherein the visual art is in the form of an image.

3. The system of claim 2, the memory further comprising instructions that, when executed by the at least one processor, cause the at least one processor to perform operations to generate a non-fungible token for the unique form of visual art using the image.

4. The system of claim 1, wherein the value is calculated using an external appraisal or valuation algorithm.

5. The system of claim 3, the memory further comprising instructions that, when executed by the at least one processor, cause the at least one processor to perform operations to:
submit the non-fungible token to a non-fungible token exchange, wherein the non-fungible token exchange includes a trading or exchange interface facilitating trading and exchange of the non-fungible token among users; and
upon receipt of an exchange or trade transaction settlement, increase the account balance of the user by an amount specified in the exchange or trade transaction settlement.

6. The system of claim 5, wherein the trading or exchange interface includes an exchange interface with controls that enable the user to exchange the non-fungible token for a carbon offset, a promotional store redemption, a charitable donation, or a currency.

7. The system of claim 6, the memory further comprising instructions that, when executed by the at least one processor, cause the at least one processor to perform operations to:
calculate a value for the nonfungible token; and
assign the value to the non-fungible token.

8. The system of claim 7, wherein the value is calculated in a form of an acquisition benefit.

9. The system of claim 7, wherein the value is calculated value in a form of a royalty stream.

10. The system of claims 7, wherein the value is allocated among a plurality of non-fungible token exchanges.

11. The system of claim 1, the memory further comprising instructions that, when executed by the at least one processor, cause the at least one processor to perform operations to:
train a machine learning processor using features extracted from training data comprising images of artworks and corresponding carbon footprint data, artwork valuation data, and carbon footprint adjusted valuation data to generate a carbon footprint valuation model;
receive the unique form of visual art as input to the machine learning processor; and
evaluate features extracted from the input using the carbon footprint valuation model to calculate the value for the artcycling event.

12. The system of claim 1, the memory further comprising instructions that, when executed by the at least one processor, cause the at least one processor to perform operations to:
access a database of an internet art valuation portal including a plurality of artworks, corresponding valuation data, and historical exhibition data from a plurality of galleries considered prestigious;
extract, by the at least one processor, a set of features from the unique form of visual art, wherein the features include at least one of visual characteristics, artist information, and historical sales data;
apply a comparative machine learning model that has been trained on the plurality of artworks and corresponding valuation data, wherein the model compares the extracted features of the unique form of visual art against similar features of artworks in the database;
adjust, by the at least one processor, an initial valuation derived from the comparative machine learning model based on, historical exhibition data of the artworks in the database in prestigious galleries and influence scores of the galleries where artworks have been exhibited, wherein the influence scores are derived from the frequency and recency of exhibitions correlated with market trends;
generate, by the processor, a valuation output for the unique from of visual art based on the adjusted valuation, wherein the valuation output is displayed to a user through the internet-based portal; and
dynamically updating, by the processor, the comparative machine learning model based on new artworks and valuation data entered into the database, and new exhibition data from the prestigious galleries, to refine future valuations.

13. A computer implemented method comprising:
receiving a unique form of visual art, created by a user, incorporating at least one consumer package;
creating a digital record, in a computer database, for the unique form of visual art, wherein the digital record comprises at least one first record of an artcycling event based on receipt of the unique form of visual art, and wherein the at least one first record comprises:
a first indication of the artcycling event, wherein the first indication indicates a time of creation of the unique form of visual art;
a second indication of the artcycling event, wherein the second indication indicates a pledge not to recycle or dispose of the at least one consumer package incorporated into the unique form of visual art; and
a visual depiction of the artcycling event;
assigning a value to the artcycling event based on an evaluation of visual elements present in the unique form of visual art; and
increasing an account balance of the user by an amount equal to the value.

14. The computer implemented method of claim 13, wherein the visual art is in the form of an image.

15. The computer implemented method of claim 14, further comprising generating a non-fungible token for the unique form of visual art using the image.

16. The computer implemented method of claim 13, wherein the value is calculated using an external appraisal or valuation algorithm.

17. The computer implemented method of claim 15, further comprising:
submitting the non-fungible token to a non-fungible token exchange, wherein the non-fungible token exchange includes a trading or exchange interface facilitating trading and exchange of the non-fungible token among users; and
upon receipt of an exchange or trade transaction settlement, increasing the account balance of the user by an amount specified in the exchange or trade transaction settlement.

18. The computer implemented method of claim 17, wherein the trading or exchange interface includes an exchange interface with controls that enable the user to exchange the non-fungible token for a carbon offset, a promotional store redemption, a charitable donation, or a currency.

19. The computer implemented method of claim 18, further comprising:
calculating a value for the nonfungible token; and
assigning the value to the non-fungible token.

20.-25. (canceled)

26. A computer-implemented method comprising:
Forming a unique form of visual art incorporating at least one consumer package created by a user;
Transmitting to a server a representation of the unique form of visual art;
Accessing by the server of a database of packages comprising data concerning the carbon footprint thereof;
Generating a first value (F), wherein the first value is a representation of the carbon footprint of the at least one consumer package used to form the form of visual art;
creating a digital record of the representation, wherein the digital record comprises at least one first record of an artcycling event based on receipt of the unique form of visual art, and wherein the at least one first record comprises:
a first indication of the artcycling event, wherein the first indication indicates a time of creation of the unique form of visual art;
a second indication of the artcycling event, wherein the second indication indicates a pledge not to recycle or dispose of the at least one consumer package incorporated into the unique form of visual art;
a visual depiction of the artcycling event; and
the first value
assigning a second value (S) to the record based on an evaluation of elements present in the unique form of visual art; and
generating a third value (T) from the first and second value, wherein the third value is represented by the formula;
(T)=W_{F}*(F)+W_{S}(S)
wherein W_{F} and W_{S} represent weights associated with the first (F) and second (S) values and are 0≤W_{F}, W_{S}≤1; and
Assigning the third value (T) to the digital record to generate a unique representation of the form of visual art.
